(19) United States
(12) Patent Application Publication
(10) Pub. No.: US 2005/0264262 A1
(43) Pub. Date: Dec. 1, 2005

(54) Charging apparatus having variable resistance unit

(76) Inventors: Myoung-Hoon Kang, Seoul (KR); Jeong-Kuk Moon, Seongnam-si (KR)

Correspondence Address: MORGAN & FINNEGAN, L.L.P., 3 WORLD FINANCIAL CENTER, NEW YORK, NY, 10281-2101, US

(21) Appl. No.: 11/137,988

(22) Filed: May 25, 2005

(30) Foreign Application Priority Data
May 27, 2004 (KR) 2004-37621

(51) Int. Cl. H02J 7/00

(52) U.S. Cl. 320/125

(57) ABSTRACT

Disclosed herein is a charging apparatus having a variable resistance unit. The charging apparatus includes an interface unit for an external power source, a variable resistance unit, a charging control unit, a current control unit and a power switch. The variable resistance unit is provided on the charging path and has a resistance value set according to the control of the charging control unit. The charging control unit reads voltage generated across the variable resistance unit, calculates current based on the read voltage and controls the variable resistance unit. The charging control unit also controls the current control unit and the power switch.

### BACKGROUND OF THE INVENTION

1. Field of the Invention

The present invention relates generally to a charging apparatus and, more particularly, to a charging apparatus for a mobile communication terminal, which is provided with a variable resistance unit, thus having improved charging performance.

2. Description of the Related Art

Conventionally, when the battery of a mobile communication terminal is charged, charging is performed using a charging apparatus, such as an electric charger. In a process of charging the battery in the conventional charging apparatus, a charging control unit reads a voltage, which is generated by current flowing through a resistor contained in the charging apparatus, using an Analog to Digital Converter (ADC). Thereafter, the amount of current charging the battery is detected using the read voltage, and the amount of charging is controlled in conformity with the capacity of the battery.

Meanwhile, at the beginning of the charging, a large amount of charging current flows, so that voltage drop across the resistor is high. When the charging has been performed for a certain period of time and, therefore, the amount of current decreases, the voltage drop across the resistor decreases. When the voltage drop across the resistor decreases, there occurs a relatively large error in the detection of variation in the amount of current based on the value read through the ADC. For example, when charging current is 1000 mA and a resistance value is 1 mΩ, a voltage of 1 mV appears across the resistor. When the charging current decreases to 10 mA, the voltage drop across the resistor is 0.01 mV. As a result, the voltage drop across the resistor varies from 1 mV to 0.01 mV, so that a problem arises in that a large error occurs during the detection of current when the voltage is read using the ADC.

As described in the above-described example, the conventional charging apparatus is problematic in that a relatively large error occurs in the detection of current because the variation in the property of the part of the conventional charging apparatus that measures voltage is large and, therefore, the amount of current charging the battery cannot be precisely adjusted.

### SUMMARY OF THE INVENTION

Accordingly, the present invention has been made keeping in mind the above problems occurring in the prior art, and an object of the present invention is to provide a charging apparatus having a variable resistance unit, which is capable of improving charging performance.

In order to accomplish the above object, the present invention provides a charging apparatus, including an interface configured to receive an external power source to supply power to the battery via a charging path thereby to charge the battery, a current control unit configured to adjust an amount of current flowing through the charging path, a variable resistance unit being provided on the charging path configured to set a variable resistance value, a power switch configured to selectively turn on and off current flowing into the battery; and a charging control unit configured to read voltage across the variable resistance unit, calculate current based on the read voltage and control the variable resistance unit according to the calculated current value.

In accordance with an aspect of the invention, the charging control unit is configured to control the current control unit and the power switch based on the read voltage across the variable resistance.

In accordance with another aspect of the invention, the charging control unit may increase the resistance value of the variable resistance unit when the voltage drop across the variable resistance unit decreases below a predetermined level.

In accordance with still another aspect of the invention, the variable resistance unit may include a plurality of resistors that are connected in parallel to each other on the charging path, and a switching unit that has a plurality of switches connected to the resistors, respectively, and operates to allow only a switch connected to one of the resistors to be turned on and switches connected to remaining resistors to be turned off so that current can flow only through the one of the resistors.

In accordance with yet another aspect of the invention, the charging control unit may turn off the switch connected to the one of the resistors through which the current flows and turn on a switch connected to another resistor having the next larger resistance value compared to a resistance value of the one of the resistors when the voltage drop across the one of the resistors through which the current flows decreases below a predetermined level.

In accordance with yet another aspect of the invention, the charging control unit may turn off the power switch when the voltage drop across the variable resistance unit decreases below a predetermined level.

Other and further aspects of the present invention will become apparent during the course of the following detailed description and by reference to the attached drawings.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the internal construction of a charging apparatus according to a preferred embodiment of the present invention; and

FIG. 2 is a diagram showing the internal construction of a variable resistance unit according to the preferred embodiment of the present invention.

### DESCRIPTION OF THE PREFERRED EMBODIMENTS

Reference now should be made to the drawings, in which the same reference numerals are used throughout the different drawings to designate the same or similar components.

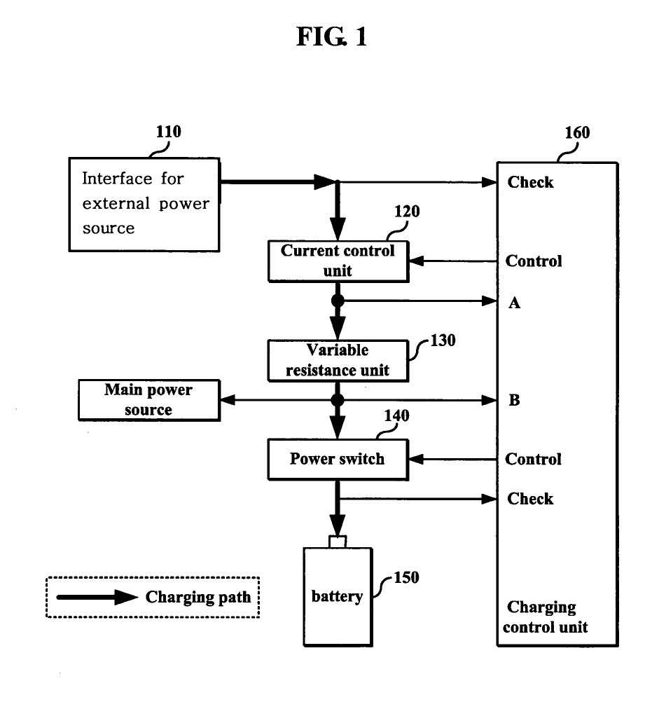

FIG. 1 is a diagram showing the internal construction of a charging apparatus according to a preferred embodiment of the present invention. The charging apparatus of the embodiment includes an interface for an external power source 110, a current control unit 120, a variable resistance unit 130, a power switch 140, a battery 150, and a charging control unit 160.

The interface for an external power source 110 supplies current along a charging path to charge the battery 150. The charging path is indicated by bold arrows in FIG. 4. From the charging path indicated in FIG. 1, it can be understood that current exiting from the interface for an external power source 110 enters the battery 150 through the current control unit 120, the variable resistance unit 130 and the power switch 140.

The variable resistance unit 130 is located on the charging path, and has a resistance value set according to the control of the charging unit 160. In the embodiment of the present invention, voltage is applied across the ends A and B.

The charging control unit 160 measures a voltage across the variable resistance unit 130, calculates a current using the read voltage, and controls the current control unit 120 and the power switch 140 according to the calculated current. In the embodiment of the present invention, the charging control unit 160 increases the resistance value of the variable resistance unit 130 when the voltage across the variable resistance unit 130 drops below a predetermined level. For example, when a current of 1000 mA flows through the variable resistance unit 130 and the resistance value of the variable resistance unit 130 is 1 mΩ, the voltage across the variable resistance unit 130 is 1 mV. When the predetermined level is 0.1 mV and the voltage across the variable resistance unit 130 is lower than 0.1 mV, the charging control unit 160 increases the resistance value of the variable resistance unit 130. For example, 1 mΩ may be increased to 10 mΩ. In this way, the variation in voltage applied across the ends of the variable resistance unit 130 is reduced, so that the error occurring when the voltage is read using the ADC can be reduced.

Furthermore, in an embodiment of the present invention, the charging control unit 160 may turn off the power switch 140 when the voltage across the variable resistance unit 130 decreases below a certain voltage. For example, when the certain voltage is 0.01 V and the voltage across the variable resistance unit 130 decreases below 0.01 V, the charging control unit 160 cuts off the current flowing into the battery 150 and terminates the charging by turning off the power switch 140.

The current control unit 120 functions to control the amount of current flowing through the charging path under the control of the charging control unit 160.

The power switch 140 functions to turn on and off the current flowing into the battery 150 under the control of the charging control unit 160.

The current flowing from the interface for an external power source 110 charges the battery 150.

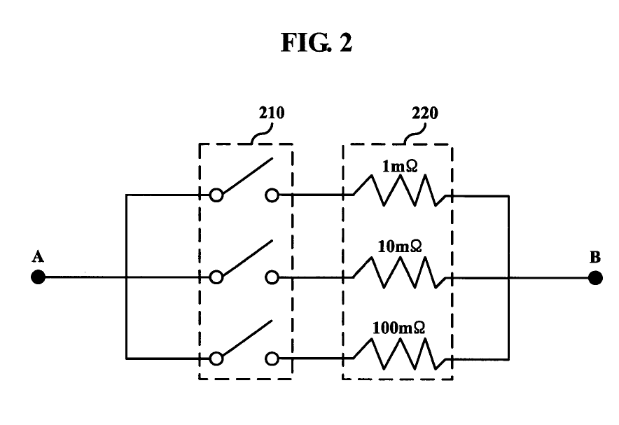

The internal structure of the variable resistance unit 130 is described in detail below with reference to FIG. 2.

FIG. 2 is a diagram showing the internal construction of the variable resistance unit 130 according to the preferred embodiment of the present invention. The variable resistance unit 130 includes a plurality of resistors 220 and a switching unit 210.

The resistors 220 are connected in parallel between the ends A and B on the charging path, and have different resistance values. The switching unit 210 has a plurality of switches. The switches are connected to respective resistors 220 so that the switch connected to one resistor is turned on and the switches connected to the remaining resistors are turned off, thus allowing current to flow through the one resistor. In the embodiment of FIG. 2, the variable resistance unit 130 is composed of three resistors and three switches.

When the voltage across the resistor through which current flows decreases below a predetermined level, the charging control unit 160 turns off the switch connected to the resistor through which the current flows and turns on the resistor having the next larger resistance value compared to that of the former resistor. Taking the case of FIG. 2 as an example, if it is assumed that only the switch connected to the resistor having a resistance value of 1 mΩ is turned on and current flowing through the resistor is 1000 mA, a voltage of 1 mV appears across A and B. When the amount of current decreases and, therefore, a current of 100 mA flows through the resistor, the voltage across A and B becomes 0.1 mV. Assuming that the predetermined level is 0.1 mV, the charging control unit 160 turns on the switch connected to the resistor having a resistance value of 10 mΩ that is next larger than that of the current resistor, and turns off the remaining switches. At this time, the voltage across A and B is 1 mV. In this way, when the voltage across A and B decreases below the predetermined level, a switch connected to a resistor having the next larger resistance value compared to that of a current resistor is turned on and the remaining switches are turned off. By performing the above-described operation, the variation in voltage across A and B is reduced, thus preventing error from increasing when the voltage is read using the ADC.

Although, in the above-described example, one switch is turned on and the remaining switches are turned off, the example is only an embodiment. In another embodiment, two switches may be turned on, so that control is performed such that resistors can be connected in parallel between A and B.

As described above, in accordance with the present invention, the charging apparatus is provided with the variable resistance unit, so that error resulting from rapid variation in voltage during charging can be reduced, thus improving charging performance. That is, the amount of charging current can be more accurately adjusted and, furthermore, the life span of the battery can be increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A charging apparatus for a battery, comprising:
an interface unit configured to receive an external power source to supply power to the battery via a charging path thereby to charge the battery;
a current control unit configured to adjust an amount of current flowing through the charging path;
a variable resistance unit being provided on the charging path configured to set a variable resistance value;
a power switch unit configured to selectively turn on and off current flowing into the battery; and
a charging control unit configured to read voltage across the variable resistance unit, calculate current based on the read voltage and control the variable resistance unit according to the calculated current value.

2. The charging apparatus as set forth in claim 1, wherein the charging control unit is further configured to control the current control unit and the power switch based on the read voltage across the variable resistance.

3. The charging apparatus as set forth in claim 1, wherein the charging control unit increases the resistance value of the variable resistance unit when the voltage across the variable resistance unit decreases below a predetermined level.

4. The charging apparatus as set forth in claim 1, wherein the variable resistance unit includes a plurality of resistors that are connected in parallel to each other on the charging path, and a switching unit that has a plurality of switches connected to the plurality of resistors, respectively, and the variable resistance unit operates to allow only a switch connected to one of the plurality of resistors to be turned on and switches connected to remaining resistors to be turned off so that current can flow only through the one of the plurality of resistors.

5. The charging apparatus as set forth in claim 4, wherein the charging control unit turns off the switch connected to the one of the plurality of resistors through which the current flows and turns on another switch connected to another resistor having a next larger resistance value compared to a resistance value of the one of the plurality of resistors when the voltage across the one of the plurality of resistors through which the current flows decreases below a predetermined level.

6. The charging apparatus as set forth in claim 1, wherein the charging control unit turns off the power switch when the voltage across the variable resistance unit decreases below a predetermined level.

7. A charging apparatus for a battery comprising:
a variable resistance unit providied on a charging path of the battery configured to change resistance value according to current flowing through the variable resistance unit; and
a charging control unit configured to read voltage across the variable resistance unit, calculate current based on the read voltage and control the variable resistance unit according to the calculated current value.

8. The charging apparatus of claim 7 further comprising an interface configure to receive an external power source to supply power to the battery via a charging path, a current control unit configured to adjust an amount of current flowing throught the charging path, and a power switch unit configured to selectively turn on and off current flowing into the battery.

9. The charging apparatus of claim 7, wherein the charging control unit increases the resistance value of the variable resistance unit when the voltage across the variable resistance unit decreases below a predetermined level.

10. The charging apparatus of claim 7, wherein the variable resistance unit includes a plurality of resistors connected in parallel to each other and a plurality of switches connected to the plurality of resistors, respectively.

11. The charging apparatus of claim 10, wherein he variable resistance unit operates to allow only a switch connected to one of the plurality of resistors to be turned on and switches connected to remaining resistors to be turned off so that current can flow only through the one of the plurality of resistors.

12. The charging apparatus of claim 10, wherein the charging control unit turns off the switch connected to the one of the plurality of resistors through which the current flows and turns on another switch connected to another resistor having a next larger resistance value compared to a resistance value of the one of the plurality of resistors when the voltage across the one of the plurality of resistors through which the current flows decreases below a predetermined level.

13. The charging apparatus of claim 8, wherein the charging control unit turns off the power switch when the voltage across the variable resistance unit decreases below a predetermined level.

14. A method of charging a battery comprising step of using a variable resistance unit on a charging path of the battery, wherein the method further comprising:
reading voltage across the variable resistance unit;
calculating current based on the voltage read on the reading step; and
adjusting resistance of the variable resistance unit based on result from the calculating step.

15. The method of claim 14 further comprising determining to determine whether the current calculated at the calculating step is higher or lower than a predetermined value.

16. The method of claim 14 further comprising increasing the resistance value of the variable resistance when the current calculated at the calculating step is lower than the predetermined level.

17. The method of claim 15 further comprising increasing the resistance value of the variable resistance when the current calculated at the calculating step is lower than the predetermined level.

18. A computer-readable medium comprising code that, when executed, causes a computer to carry out charging of a battery using a variable resistance unit on a charging path of the battery, wherein the charging of a battery further comprising steps of:
reading voltage across the variable resistance unit;
calculating current based on the voltage read on the reading step; and
adjusting resistance of the variable resistance unit based on result from the calculating step.

19. The computer-readable medium of claim 18 further comprising code for determining to determine whether the current calculated at the calculating step is higher or lower than a predetermined value.

20. The computer-readable medium of claim 18 further comprising code for increasing the resistance value of the variable resistance when the current calculated at the calculating step is lower than the predetermined level.
